(19) United States
(12) Patent Application Publication
(10) Pub. No.: US 2026/0123653 A1
(43) Pub. Date: May 7, 2026

(54) Foam Enhancing Phospholipid Emulsion Systems

(71) Applicant: Abstrax Tech Inc., Tustin, CA (US)

(72) Inventors: Marcos A. Ojeda, Tustin, CA (US); Marlene A. McGorrin, Tustin, CA (US); Iain W.H. OSWALD, Tustin, CA (US); Thomas J. Martin, Jr., Tustin, CA (US); Kevin A. KOBY, Tustin, CA (US)

(21) Appl. No.: 19/380,822

(22) Filed: Nov. 5, 2025

Related U.S. Application Data
(60) Provisional application No. 63/717,252, filed on Nov. 6, 2024.

(51) Int. Cl. A23L 2/52; A23B 2/771; A23L 27/00; A23P 30/40

(52) U.S. Cl. CPC A23L 2/52; A23B 2/771; A23L 27/80; A23P 30/40

(57) ABSTRACT

Compositions in the form of an oil-in-water emulsion composition include an oil phase that includes a flavorant; and a continuous aqueous phase that includes water, a preservative and a phospholipid emulsifying agent, and optionally an emulsifier adjuvant; wherein the phospholipid emulsifying agent includes a low content of primary ammonium functional groups.

### CROSS REFERENCE TO RELATED APPLICATIONS

This application claims the benefit of U.S. Provisional Application No. 63/717,252, filed Nov. 6, 2024, the disclosures of which is incorporated herein by reference in its entirety.

### FIELD

The present invention generally relates to a novel phospholipid emulsion system designed to maintain the foam stability. In particular, the present invention relates to emulsion systems, specifically phospholipid-based emulsions, and their application in beverages to maintain foam stability.

### BACKGROUND

The following discussion is provided to aid the reader in understanding the disclosure and is not admitted to describe or constitute prior art thereto.

Emulsion systems are widely used in the food and beverage industry to improve texture, stability, and mouthfeel. In beverages like beer, foam stability is a critical quality attribute that impacts consumer perception and enjoyment. Traditional emulsion systems often utilize lecithin due to its emulsifying properties. However, lecithin is known to adversely affect foam characteristics, leading to poor foam retention and stability. The negative impact of lecithin on foam stability is primarily attributed to its high content of free ammonium groups. These groups can interact with proteins and other chemical constituents within the beverage, disrupting the natural network of proteins, hop acids, and polyphenols that stabilize foam. This interaction results in a deterioration of foam quality, which is undesirable in products such as beer.

At present, there is therefore a need for the development of an emulsion system that overcomes the drawbacks of traditional systems like lecithin.

### SUMMARY

In one first aspect, an oil-in-water emulsion composition includes an oil phase that includes about 0.01 wt. % to about 30 wt. % of a flavorant; and optionally about 0.01 wt. % to about 10 wt. % of an emulsifier adjuvant; and a continuous aqueous phase of water; containing about 0.01 wt. % to about 30 wt. % of a preservative; and about 0.01 wt. % to about 10 wt. % of a phospholipid emulsifying agent, wherein the phospholipid emulsifying agent comprises from about 0.001 mmol to about 1.0 mmol of primary ammonium functional group per gram of the phospholipid emulsifying agent.

In some embodiments, the phospholipid emulsifying agent comprises a lecithin. In one embodiment, the lecithin comprises a sunflower lecithin. In one embodiment, the phospholipid emulsifying agent comprises from about 0.04% to about 0.6% by weight of Phosphatidylinositol (PI), from about 0.04% to about 0.1% by weight of Lysophosphatidylinositol (LPI), from about 0.1% to about 0.2% by weight of Phosphatidylethanolamines (PE), and/or from about 0.3% to about 0.6% of Phosphatidylcholines (PC). In one embodiment, the oil-in-water emulsion composition includes an aqueous phase which includes about 0.01% to about 5% by weight of the total weight of the emulsion composition, of the phospholipid emulsifying agent.

In one embodiment, the oil phase comprises about 0.01 wt. % to about 10 wt. % of a flavorant. In one embodiment, the flavorant in the oil-in-water emulsion composition includes one or more of hop oil, cannabis oil, hemp oil, hop extract, flavorant blends, hop-derived flavorant compounds, carrier oil, and non-hop derived flavorant compounds, or a combination of any two or more thereof. In one embodiment, the flavorant comprises one or more of terpene, terpene blends, thiols, ketones, esters, aldehydes, alcohols, polyfunctional alcohols, polyfunctional thiols, heterocycles, and phenolics. In one embodiment, the flavorant comprises terpenes or a blend of terpenes.

In one embodiment, the oil-in-water emulsion composition includes an aqueous phase which comprises about 0.01 wt. % to about 10 wt. % of a preservative comprising a hop acid and/or a salt thereof. In one embodiment, the hop acid comprises one or more of an alpha acid, a beta acid, a tetra acid, and an iso-alpha acid. In one embodiment, the hop acid may be humulone, cohumulone, adhumulone, lupulone, colupulone, adlupulone, tetrahydroisohumulone, tetrahydroisocohumulone, tetrahydroadlupulone, isohumulone, isocohumulone, and isoadhumulone. In one embodiment, the hop acid salt may be potassium humulone, potassium cohumulone, potassium cohumulone, potassium humulone, potassium cohumulone, potassium adhumulone, potassium lupulone, potassium colupulone, potassium adlupulone, potassium tetrahydroisohumulone, potassium tetrahydroisocohumulone, potassium tetrahydroadlupulone, potassium isohumulone, potassium isocohumulone, and potassium isoadhumulone, or a combination of any two or more thereof.

In one embodiment, the oil-in-water emulsion composition includes an aqueous phase which comprises about 0.01 wt. % to about 10 wt. % of a preservative comprising a vitamin and a salt thereof. In one embodiment, the vitamin comprises ascorbic acid (Vitamin C), tocopherol (Vitamin E), vitamin A carotene, derivatives thereof and salts thereof. In one embodiment, the vitamin may be ascorbic acid, α-, β-, γ-, δ-, ϑ-tocopherol, α-, β-, γ-, δ-, tocotrienol, or a combination of any two or more thereof. In one embodiment, the vitamin salt may be sodium ascorbate, calcium ascorbate, potassium ascorbate, ascorbyl palmitate, sodium ascorbyl phosphate, and magnesium ascorbyl phosphate.

In one embodiment, the oil-in-water emulsion composition further includes an additional emulsifying agent may be gum arabic, ester gum, acacia gum, xanthan gum, guar gum, carrageenan, locust bean gum, monoglycerides, diglycerides, ethoxylated castor oil, albumin, alginates, casein, egg yolk, or glycerol monostearate, and a combination of any two or more thereof. In one embodiment, the emulsifying agent comprises a sunflower lecithin. In one embodiment, the emulsifying agent comprises a sunflower lecithin having less than 35% phosphatidylcholine. In one embodiment, the emulsifying agent comprises a sunflower lecithin having from about 10% to about 35% phosphatidylcholine. In one embodiment, the emulsifying agent comprises a sunflower lecithin having from about 10% to about 30% phosphatidylcholine. In one embodiment, the oil-in-water emulsion composition comprises about 0.01% to about 5% by weight of the total weight of the emulsion composition of the emulsifying agent.

In one embodiment, the emulsifier adjuvant in the oil-in-water emulsion composition may be citric acid, malic acid, tartaric acid, ascorbic acid, caffeic acid, ferulic acid, and salts thereof. In one embodiment, the oil-in-water emulsion composition comprises about 0.01% to about 5% by weight of the total weight of the emulsion composition of the emulsifier adjuvant.

In one embodiment, the water is present in an amount corresponding to the remaining balance of material in the oil-in-water emulsion composition. In one embodiment, the oil-in-water emulsion composition is substantially free of weighting agents and/or gum acacia.

According to another aspect, a stable foam formulation is provided, which includes an oil-in-water emulsion composition which includes an oil phase that includes about 0.01 wt. % to about 30 wt. % of a flavorant; and optionally about 0.01 wt. % to about 10 wt. % of an emulsifier adjuvant; and a continuous aqueous phase of water; containing about 0.01 wt. % to about 30 wt. % of a preservative; and about 0.01 wt. % to about 10 wt. % of a phospholipid emulsifying agent, wherein the phospholipid emulsifying agent comprises from about 0.001 mmol to about 1.0 mmol of primary ammonium functional group per gram of the phospholipid emulsifying agent. In one embodiment, provided is a stable foam formulation comprising the oil-in-water emulsion composition of the present technology. In one embodiment, provided is a beverage comprising the oil-in-water emulsion composition of the present technology. In one embodiment, the beverage is beer. In one embodiment, the concentration of the emulsion composition in the beverage ranges from about 0.1% to about 5% by volume.

According to yet another aspect, a beverage is provided, which includes an oil-in-water emulsion composition which includes an oil phase that includes about 0.01 wt. % to about 30 wt. % of a flavorant; and optionally about 0.01 wt. % to about 10 wt. % of an emulsifier adjuvant; and a continuous aqueous phase of water; containing about 0.01 wt. % to about 30 wt. % of a preservative; and about 0.01 wt. % to about 10 wt. % of a phospholipid emulsifying agent, wherein the phospholipid emulsifying agent comprises from about 0.001 mmol to about 1.0 mmol of primary ammonium functional group per gram of the phospholipid emulsifying agent. In one embodiment, the beverage is beer, an alcohol containing beverage, or a non-alcohol containing beverage product. In one embodiment, the beverage product is a fermented beverage. In one embodiment, the beverage is beer. In one embodiment, the concentration of the emulsion composition in the beverage ranges from about 0.1% to about 5% by volume.

According to yet another aspect, provided is a method comprising: (i) providing an oil phase comprising a flavorant and optionally an emulsifier adjuvant; (ii) providing an aqueous phase comprising water a phospholipid emulsifying agent, and optionally an emulsifier adjuvant; (iii) mixing the oil phase and the aqueous phase so as to obtain a pre-emulsion; and (iv) homogenizing the pre-emulsion to obtain an oil-in-water emulsion; wherein the phospholipid emulsifying agent comprises about 0.001 to about 1.0 mmol of primary ammonium functional group per gram of the phospholipid emulsifying agent. In one embodiment, the homogenizing comprises a multi-stage homogenization process.

According to another aspect, provided is a method for stabilizing a foam composition, the method comprising adding to the foam composition an oil-in-water emulsion comprising from about 0.01 wt. % to about 10 wt. % of a phospholipid emulsifying agent, wherein the phospholipid emulsifying agent comprises about 0.001 to about 1.0 mmol of primary ammonium functional group per gram of the phospholipid emulsifying agent.

### BRIEF DESCRIPTION OF THE DRAWINGS

FIG. 1 is a graph showing combined results achieved for foam stability of beer, measured as the amount of time required for foam to decay 10, 20, and 30 mm, using various emulsion compositions containing Sunlipon® PI30 as the emulsifying agent (AD-AH) and a control free of emulsifying agent.

FIG. 2 is a graph showing results achieved for foam stability of beer, measured as the amount of time required for foam to decay 10, 20, and 30 mm, using an emulsion composition containing Sunlipon® PI30 as the emulsifying agent (AD) and a control, free of emulsifying agent, in one embodiment of the present technology.

FIG. 3 is a graph showing results achieved for foam stability of beer, measured as the amount of time required for foam to decay 10, 20, and 30 mm, using an emulsion composition containing Sunlipon® PI30 as the emulsifying agent (AE) and a control, free of emulsifying agent, in one embodiment of the present technology.

FIG. 4 is a graph showing results achieved for foam stability of beer, measured as the amount of time required for foam to decay 10, 20, and 30 mm, using an emulsion composition containing Sunlipon® PI30 as the emulsifying agent (AF) and a control, free of emulsifying agent, in one embodiment of the present technology

FIG. 5 is a graph showing results achieved for foam stability of beer, measured as the amount of time required for foam to decay 10, 20, and 30 mm, using an emulsion composition containing Sunlipon® PI30 as the emulsifying agent (AG) and a control, free of emulsifying agent, in one embodiment of the present technology.

FIG. 6 is a graph showing results achieved for foam stability of beer, measured as the amount of time required for foam to decay 10, 20, and 30 mm, using an emulsion composition containing Sunlipon® PI30 as the emulsifying agent (AH) and a control, free of emulsifying agent, in one embodiment of the present technology.

FIG. 7 is a box plot showing a compact and statistical visualization of heatmap difference for foam stability of beer, using inventive emulsion compositions containing Sunlipon® PI30 as the emulsifying agent relative to the control, with the box represents the distribution of percent deviations from the control across all compositions (AD-AH) and depths (10, 20, 30 mm).

FIG. 8 is a graph showing distribution of % difference for foam stability of beer, measured for inventive emulsion compositions.

FIGS. 9A-9D. FIG. 9A depicts the structure of Phosphatidylinositol (PI), FIG. 9B depicts the structure of Lysophosphatidylinositol (LL), FIG. 9C depicts the structure of Phosphatidylethanolamine (PE), and FIG. 9D depicts the structure of Phosphatidylcholines (PC).

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As utilized herein with respect to numerical ranges, the terms “approximately,” “about,” “substantially,” and similar terms will be understood by persons of ordinary skill in the art and will vary to some extent depending upon the context in which it is used. If there are uses of the terms that are not clear to persons of ordinary skill in the art, given the context in which it is used, the terms will be plus or minus 10% of the disclosed values. When “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments, and does not pose a limitation on the scope of the claims unless otherwise stated. No language in the specification should be construed as indicating any non-claimed element as essential.

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified. As a non-limiting example, a reference to “X and/or Y” can refer, in one embodiment, to X only (optionally including elements other than Y); in another embodiment, to Y only (optionally including elements other than X); in yet another embodiment, to both X and Y (optionally including other elements).

Unless indicated otherwise, reference to “percent” is to be understood as “weight percent,” and reference to “ratio” is as a weight/weight ratio.

As used herein, the term “terpene compound” is understood to mean any organic compound that contains some isoprene subunit within its structure and their oxygenated derivatives.

As used herein, the terms “odor” and “aroma” are used interchangeably and represent the sensory attributes of certain substances perceptibly determined by the olfactory system.

As used herein, the term “emulsion”, refers to a class of disperse systems containing two immiscible liquids (e.g., oil and water), with one of the liquids being dispersed as small spherical droplets (the dispersed phase) in the other (the continuous phase). Emulsions can be characterized by the nature of the emulsifier, the structure or of the emulsion or both. Representative emulsions by structure include oil-in-water (o/w) emulsions, water-in-oil (w/o) emulsions, and oil-in-oil (w/o) emulsions.

As used herein, the term “oil-in-water emulsion” or “o/w emulsion” refers to a composition where small droplets of oil are immersed in water or another liquid. Oil is therefore the dispersed phase, while water is the dispersion medium.

As used herein, the term “water-in-oil emulsion” or “w/o emulsion” refers to a composition where small droplets of water are immersed in oil or another liquid. Water is therefore the dispersed phase, while oil is the dispersion medium.

The term “emulsifier adjuvant” as used herein refers to an agent present in either the oil phase or water phase or both that enhances and/or modifies the action and/or effectiveness of an emulsifier.

As used herein, the term “flavoring agent” or “flavorant” is understood to mean a substance that is meant to impart and/or improve the flavor (taste) and/or aroma impression of substances e.g., food or other substances, and can include both natural and synthetic ingredients. For example, a flavorant can include an aroma and/or a flavor agent. The flavorants may include additional additive(s) that provide additional functional benefits.

The term “flavor enhancer” as used herein refers to substances added to supplement, enhance, or modify the original taste and/or aroma of a food, without imparting a characteristic taste or aroma of its own.

The term “full spectrum hop extract” as used herein refers to a hop material that has not been separated beyond the initial extract produced from the extraction process.

As used herein, the term “primary ammonium group” refers to a compound which structure

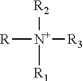

in which each of R₁, R₂, and R₃ is a hydrogen atom (e.g., —R—NH₃⁺).

The term “flavorant emulsion” as used herein refers to an emulsion in which one or more flavorants and/or flavorants are incorporated.

As used here, the term “weighting agent” has its ordinary meaning to those skilled in the art. In general, it refers to an additive that is used to increase the density of a composition, and which aids in keeping an ingredient homogenously dispersed or suspended in the emulsion. As an example, a weighting agent can be an additive incorporated into the oil phase of certain types of emulsions to inhibit gravitational separation of the oil droplets from the water phase.

As used herein, the term “substantially free” may refer to a composition that has little or no content of the stated component. For instance, “substantially free of weighting agent” refers to a composition that has little or no weighting agent, e.g., the content of weighting agent is less than about 0.1 wt. %, less than about 0.01 wt. %, less than about 0.001 wt. %, or less than about 0.0001 wt. % based on the weight of the composition. In some embodiments, the composition is free of the stated component.

Traditional emulsion systems often utilize emulsifiers such as lecithin, which is known to adversely affect foam characteristics, leading to poor foam retention and stability. The inventors, in their quest to replace lecithin-like emulsifiers which are harmful to foam retention, surprisingly discovered an emulsion system that maintains or enhances foam stability in beverages by utilizing a fraction of phospholipids with a lower content of primary ammonium functional groups, thereby preventing foam-negative interactions.

The present technology provides a novel phospholipid emulsion system designed to maintain foam stability in beverages like beer. Unlike traditional emulsion systems which use emulsifying agents such as lecithin, which negatively impact foam characteristics, the phospholipid emulsion system of the present technology contains fewer primary ammonium functional groups.

Lecithin is widely used as an ingredient in the food industry due to its diverse functionality, mainly attributed to phospholipids (PL), the principal constituents. Lecithin is composed of a complex mixture of acetone-insoluble phosphatidyl esters, consisting mainly of phosphatidyl choline, phosphatidyl ethanolamine, phosphatidyl serine, and phosphatidyl inositol, combined with other substances such as phosphatidic acids, triglycerides, fatty acids, and carbohydrates. Phosphatidyl choline is a class of phospholipids that incorporate the quaternary ammonium cation choline [(CH₃)₃NCH₂CH₂OH]⁺. Phosphatidyl ethanolamine incorporates the ammonium cation [H₃NCH₂CH₂OH]⁺ and phosphatidyl serine incorporates the ammonium cation [H₃NCHCO₂CH₂OH]⁺. Finally, phosphatidyl inositol incorporates the myo-inositol (C₆H₁₂O) carbohydrate. The inventors surprisingly discovered that a reduction in the primary ammonium groups of the emulsifying agent, such as e.g., those in phosphatidyl ethanolamine and phosphatidyl serine, prevents interactions with proteins and other constituents, preserving the natural network of proteins, hop acids, and polyphenols that stabilize foam. The present technology ensures the desirable foam properties of beverages are maintained while delivering the benefits of an effective emulsion system.

Thus, in one aspect, provided herein are emulsion compositions which include one or more phospholipid emulsifying agents having a low content of primary ammonium groups. For example, low content, in one embodiment, refers to a percentage of primary ammonium-containing compounds within a mixture. For instance, considering the phospholipid emulsifying agents as 100% of phospholipids in a formula for a emulsifying agent, then a “low” content may be defined as having less than about 30% phospholipids as Phosphatidylcholines (PC), including, for example, less than about 25%, less than about 20%, less than about 15%, less than about 10%, less than about 8% or less than 5% of Phosphatidylcholines, when compared to the total lipids in the emulsifying agent. The total lipids used in the emulsifying agent are those that contain primary ammonium groups (e.g., phosphatidylethanolamines (PE) and phosphatidylcholines (PC)). For example, if PI30 has 8% PC and 8% PE, the primary ammonium group content is low by either of these definitions, being about 0.213 mmol/g and 16% of the total phospholipids. The phospholipid emulsifying agent or fraction is obtained through an extraction and purification process designed to reduce the content of primary ammonium functional groups of phospholipids. In one embodiment, the one or more phospholipid emulsifying agents may include from about 0.04%-0.6% by weight of Phosphatidylinositol (PI), from about 0.04%-0.1% by weight of Lysophosphatidylinositol (LPI), from about 0.1%-0.2% by weight of Phosphatidylethanolamines (PE), and from about 0.3%-0.6% of Phosphatidylcholines (PC).

In one embodiment, the phospholipid emulsifying agents includes from about 0.0001 mmol to about 10 mmol of primary ammonium functional group per gram of the phospholipid emulsifying agent. This includes from about 0.001 mmol to about 8 mmol, from about 0.001 mmol to about 5 mmol, 0.001 mmol to about 2 mmol, 0.001 mmol to about 1 mmol, or 0.01 mmol to about 0.5 mmol, of primary ammonium functional group per gram of the phospholipid emulsifying agent, or any range including and/or in-between any two of these values.

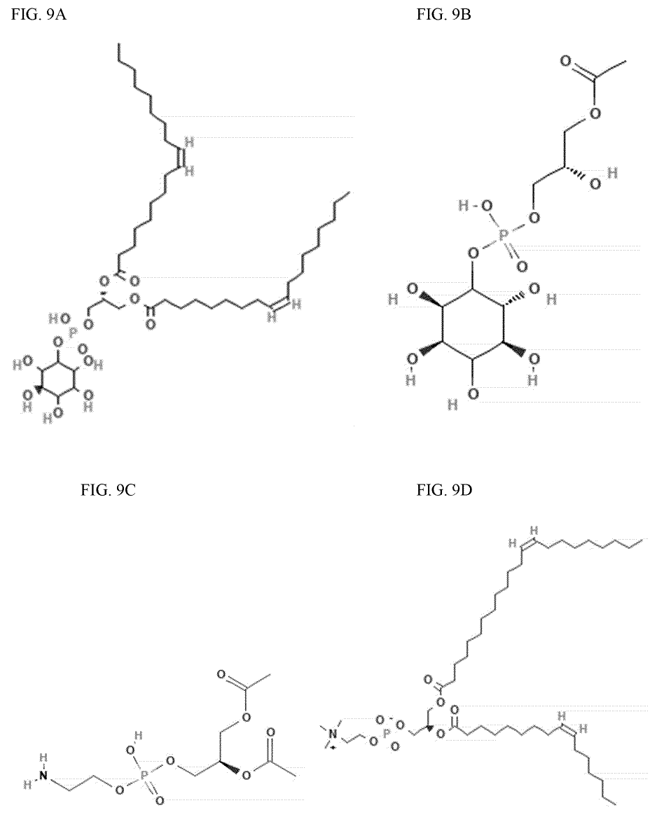

In one embodiment, the phospholipid emulsifying agents include soy lecithin, sunflower lecithin, rapeseed lecithin, canola lecithin, safflower lecithin, egg lecithin, and the like or combinations thereof. In one embodiment, the phospholipid emulsifying agent includes a sunflower phospholipid (sunflower lecithin), e.g., from Perimondo under the brand names of SunliponR, including SunliponR PI30, which are phospholipids from sunflower lecithin containing lower amount of phosphatidylcholine. In one embodiment, the phospholipid emulsifying agent used in the methods and compositions of the present technology contain lower amount of phosphatidylcholine compared to the amount of phosphatidylcholine in regular lecithin or sunflower lecithin containing 65%, 60% or 50% phosphatidylcholine. The phospholipid emulsifying agent may include Phosphatidylcholine (PC), Phosphatidylethanolamine (PE), Phosphatidylinositol (PI), Lysophosphatidylinositol (LL), phosphatidylserine (PS), phosphatidic acid (PA), or a combination of any two or more thereof. In one embodiment, the phospholipid emulsifying agent may include Phosphatidylinositol (PI), Lysophosphatidylinositol (LL) Phosphatidylethanolamine (PE), and Phosphatidylcholine (PC), or a combination of any two or more thereof. The structure of the exemplary phospholipids present in the phospholipid emulsifying agent is shown in FIGS. 9A-9D.

In one embodiments, the phospholipid emulsifying agent is a lower phosphatidyl choline derivative or variant of lecithin. In some embodiments, the phospholipid emulsifying agent is a phosphotidyl choline derivative or variant of sunflower lecithin. In one embodiment, the amount of phosphotidyl choline in the phospholipid emulsifying agent ranges from about 1% to about 10%. In one embodiment, the phospholipid emulsifying agent may include not more than 30%, not more than 31%, not more than 32%, not more than 33%, not more than 34%, or not more than 35% of Phosphatidylinositol (PI). In one embodiment, the phospholipid emulsifying agent may include not more than 0.1%, not more than 0.5%, not more than 1%, not more than 1.5%, not more than 2%, not more than 2.5%, not more than 3%, not more than 3.5%, not more than 4%, not more than 4.5% or not more than 5% of Lysophosphatidylinositol (LL). In one embodiment, the phospholipid emulsifying agent may include not less than 12%, not less than 10%, not less than 8%, not less than 6%, or not less than 5% of Phosphatidylethanolamines (PE). In one embodiment, the phospholipid emulsifying agent may include not less than 12%, not less than 10%, not less than 8%, not less than 6%, or not less than 5% of Phosphatidylcholines (PC). In one embodiment, the phospholipid emulsifying agent may include Phosphatidylcholines (PC) in an amount of about 1% to about 20%, by weight of the total amount of the phospholipid emulsifying agent, including without limitation, about 2% to about 15%, about 3% to about 12%, about 4% to about 10%, about 5% to about 8%, or about 6% to about 7%, of the total weight of the phospholipid emulsifying agent, or any range including and/or in-between any two of these values. In one embodiment, the phospholipid emulsifying agent may include Phosphatidylinositol (PI) in an amount of about 1% to about 40%, by weight of the total amount of the phospholipid emulsifying agent, including without limitation, about 5% to about 35%, about 8% to about 32%, about 10% to about 30%, about 12% to about 28%, or about 15% to about 25%, of the total weight of the phospholipid emulsifying agent, or any range including and/or in-between any two of these values. In one embodiment, the phospholipid emulsifying agent may include Lysophosphatidylinositol (LL) in an amount of about 0.001% to about 10%, by weight of the total amount of the phospholipid emulsifying agent, including without limitation, about 0.05% to about 8%, about 0.1% to about 5%, about 0.5% to about 4%, about 1% to about 3.5%, or about 1.5% to about 3%, of the total weight of the phospholipid emulsifying agent, or any range including and/or in-between any two of these values. In one embodiment, the phospholipid emulsifying agent may include Phosphatidylethanolamine (PE) in an amount of about 1% to about 20%, by weight of the total amount of the phospholipid emulsifying agent, including without limitation, about 2% to about 15%, about 3% to about 12%, about 4% to about 10%, about 5% to about 8%, or about 6% to about 7%, of the total weight of the phospholipid emulsifying agent, or any range including and/or in-between any two of these values. In one embodiment, the SunliponR PI 30, may contain 30-40% phosphatidylinositol (PI), less than 8% Lysophosphatidylinositol, less than 8% % phosphatidylethanolamine (PE), and less than 8% % phosphatidylcholine (PC).

The emulsion composition may include about 0.0001% to about 30% of the said phospholipid emulsifying agent by weight of the total weight of the emulsion composition. In one embodiment, the emulsion composition may include up to about 30% by weight of the said phospholipid emulsifying agent of the total emulsion composition, including up to about 20%, up to about 10%, up to about 5%, up to about 2%, up to about 1% or up to about 0.1% by weight of the total weight of the emulsion composition. In one embodiment, the emulsion composition may include at least about 0.0001% by weight of the said phospholipid emulsifying agent of the total weight of the emulsion composition, including at least about 0.001%, at least about 0.01%, at least about 0.05%, at least about 0.1%, at least about 0.5%, at least about 1% or at least about 2% by weight.

In addition to the phospholipid emulsifying agent, the emulsion compositions may include additional emulsifying agents may in the water phase. Suitable additional emulsifying agents include, but are not limited to, proteins, whey proteins, amino acids, sorbic acid, potassium sorbate, sorbitan monooleate, sorbitan monolaurate (SPAN 20), sorbitan monopalmitate, sorbitan monostearate, sorbitan monostearate, xanthan gum, guar gum, carrageenan, locust bean gum, monoglycerides, diglycerides, ethoxylated castor oil, albumin, alginates, casein, egg yolk, glycerol monostearate, and the like and a combination of any two or more thereof. In one embodiment, the emulsifying agent includes proteins, e.g., chickpea protein, pea protein (Pisum Sativum), pea protein isolates, fava bean proteins, oat proteins, oat protein concentrates, barley proteins, barley protein concentrates, sesame seed proteins, sesame protein concentrates, zein (from corn), pulse proteins, defatted plant proteins, seed storage proteins, almond (Prunus dulcis L.) protein isolates, canola protein isolates, and the like or a combination of any two or more thereof. In one embodiment, the emulsifying agent includes whey protein concentrates (WPC), hydrolyzed whey protein concentrates, whey protein isolates (WPI), egg white proteins, gelatins, or a combination of any two or more thereof. In one embodiment, the emulsifying agents include amino acids, e.g., glycine, proline, hydroxyproline, phospholipids and the like or a combination of any two or more thereof.

When included in the emulsion composition, either in the oil phase or the water phase or both, the emulsion composition may include from about 0.001% to about 20% of the emulsifying agents by weight of the total weight of the emulsion composition, including without limitation, about 0.005% to about 15%, about 0.01% to about 10%, about 0.05% to about 8%, about 0.1% to about 5%, about 0.1% to about 3%, or about 0.1% to about 2% by weight of the total weight of the emulsion composition or any range including and/or in-between any two of these values. In certain embodiments, the emulsifying agent is present in an amount of from about 0.001 wt. % to about 20 wt. %, based on the total weight of the of the emulsion composition.

The emulsion compositions may include one or more flavorants, in the water phase, the oil phase or both. The flavorants may be used as such or diluted in a suitable carrier including but not limited to triacetin, triethyl citrate, limonene, or other common carriers. Suitable flavorants may include natural, plant-derived compounds or synthetic compounds, and are derived or prepared based on certain specific desired taste and/or aroma characteristics. For example, certain flavorants are derived from a plant of Humulus lupulus or from Cannabis sativa. Certain flavorants are derived from or created to mimic the flavorants of products such as fruits, spices, herbs, flowers and the like, or combinations thereof. For example, the flavorant can be selected, e.g., based on the desired aroma and/or flavor characteristics (e.g., fruity, citrus-like, flowery, spicy/herbal, tropical, earthy, piney, and the like).

In one embodiment, the flavorants may include an unmodified or modified or product of an extract. In one embodiment, the flavorants may include an unmodified or modified hop extract. In one embodiment, the flavorant may include raw hop extract (i.e., unrefined as in we did not separate it into parts, such as the terpene fraction, acid fraction, etc.). In one embodiment, the flavorant may include crude hop extract.

Other suitable flavorants for making flavorant emulsions may include, but are not limited to, plant essential oils; botanical extracts (e.g., extracts from plants and plant materials), plant proteins, polysaccharides, starches, gums, oils, antioxidants, hydrocolloids, glucans; natural and artificial flavorants (e.g., substances added to impart aroma and/or flavor); natural and artificial flavor enhancers (e.g., substances added to supplement, enhance, or modify the original taste and/or aroma without imparting a characteristic taste or aroma of their own); natural and artificial flavoring agents and adjuvants (e.g., substances added to impart or help impart a taste or aroma in food); natural and artificial sweeteners-both nutritive and non-nutritive; natural and artificial antioxidants and their salts (e.g., butylated hydroxyanisole (BHA) and butylated hydroxytoluene (BHT), ferulic acid, caffeic acid, etc.); natural and artificial vitamins and their salts (e.g., Vitamin C (ascorbic acid), sodium ascorbate, potassium ascorbate, Vitamin E, Vitamin B, Vitamin K, etc.); natural and artificial nutrient supplements (e.g., substances necessary for the body's nutritional and metabolic processes, such as calcium, magnesium, potassium, etc.); antimicrobial agents (e.g., substances used to preserve food by preventing the growth of microorganisms and spoilage, including fungistats, mold inhibitors, and preservatives such as sorbic acid, and benzoate, suitable for use in consumable and topically applied substances); flavorants derived from or mimicking fruits, spices, herbs, flowers, and the like and combinations thereof; blends of plant-based and non-plant-based flavors (e.g., sweeteners, acids, salts, bittering agents, vitamins, minerals, proteins, hydrocolloids, carbohydrates, fats, oils, waxes, gums, and resins); celluloses and hemi-celluloses, other cellulosic materials, lignins, soluble and insoluble fiber, pectins, tannins, and particulate materials from plants; proteins, polysaccharides, sugars, starches, hydrocolloids, gums, oils, antioxidants, glucans, and acids: found in barley and oats; volatile and semi-volatile compounds from plants and plant materials: including terpenes, terpenoids, terpene blends, thiols, ketones, esters, aldehydes, alcohols, polyfunctional thiols, heterocycles and phenolics; compounds found in hops: resins, oils, waxes, tannins, proteins, pectins, cellulosic materials, alpha-acids, beta-acids, iso-alpha acids, isomerized and un-isomerized acids, rho iso-extract, tetra iso-extract, xanthohumol, polyphenols, and combinations thereof; and compounds found in cannabis (e.g., resins, oils, terpenes, waxes, tannins, proteins, pectins, cellulosic materials, cannabidiol (CBD), cannabidiolic acid (CBDA), tetrahydrocannabinol (THC), tetrahydrocannabinolic acid (THCA), cannabigerol (CBG), cannabichromene (CBC), cannabinol (CBN), cannabielsoin (CBE), iso-tetrahydrocannabinol (iso-THC), cannabicyclol (CBL), cannabicitran (CBT), cannabivarin (CBV), tetrahydrocannabivarin (THCV), cannabidivarin (CBDV), cannabichromevarin (CBCV), cannabigerovarin (CBGV), cannabigerol monomethyl ether (CBGM), cannflavin A, B or C, polyphenols, salts thereof, derivatives thereof, cannabis oil, cannabis extract and combinations thereof).

In one embodiment, the flavorant may include hop oil (e.g., hop essential oil, hop oil, full spectrum hop extract), hop extract (e.g., rho iso-extract, tetra iso-extract), flavonoids (e.g., xanthohumol), polyphenols, carrier oils, flavorant blends, other hop derived compounds such as the salt forms of alpha-acids, beta-acids, polyphenols, etc., or non-hop derived flavorant compound, or a combination of any two or more thereof.

Carrier oils may include common flavor carriers, which can improve the sweetness, texture, and shelf life of food and beverages. Suitable flavor carriers include, without limitation, limonene—an organic carrier for organic molecules, triacetin—a viscous carrier commonly used for small volatiles, triethyl citrate—a viscous carrier commonly used for small volatiles, MCT, SCT, LCT (medium (6-12), short (<6), and long chain triglycerides (13-21)) oil-triglycerides that are used as carriers for other compounds, alpha-bisabolol—a sesquiterpenoid that has high solubility with organic compounds, element—a sesquiterpene carrier used for organic compounds, phytol—a diterpenoid carrier used for organic compounds, iso-phytol—a diterpenoid carrier used for organic compounds. Carrier oils, including flavor carriers can be a better alternative to petroleum-based additives because they have anti-bacterial properties and improve humectancy, can help with manufacturing safety and convenience, and can help control how and when flavor is released in a food product.

In one embodiment, the flavorant may be cannabis or hemp based, including extracts of cannabis and hemp. In one embodiment, the flavorant may include cannabinoid compounds. In one embodiment, the flavorant may include a terpene compound, a cannabinoid active agent, and an organosulfur compound. In one embodiment, the flavorant includes bittering acids, and wherein the un-isomerized bittering acids are emulsified to increase water solubility. In one embodiment, the flavorant includes un-isomerized bittering acids, and wherein the un-isomerized bittering acids are emulsified to increase water solubility.

In one embodiment, the flavorant may include ‘flavor enhancers’ such as natural and artificial edible acids and their salts (e.g., food-grade acids and their salts); and fruit acids and their salts (e.g., tartaric acid, citric acid, malic acid, magnesium citrate, sodium citrate, potassium citrate, potassium bitartrate, potassium tartrate, sodium tartrate).

In one embodiment, the flavorant(s) may include, but are not limited to terpenes, terpenoids, terpenes, terpenoids, or blends of terpenes. In one embodiment, the flavorant includes terpenes. Illustrative terpenes include, but are not limited to, α-bisabolol, borneol, camphene, camphor, β-caryophyllene, γ-3-carene, caryophyllene oxide, α-cedrene, β-eudesmol, fenchol, geraniol, guaiol, α-humulene, isoborneol, limonene, linalool, menthol, myrcene, nerol, cis-ocimene, trans-ocimene, α-phellandrene, α-pinene, β-pinene, sabinene, α-terpinene, α-terpineol, terpinolene, α-guaiene, elemene, farnesene, germacrene, guaiol, bergotamene, thujene, ylangene, sabinene hydrate, pinanol, selina-3,7 (11)-diene, eudesm-7 (11)-en-4-ol, valencene, and the like and combinations and blends thereof. In some embodiments, the flavorants include commercially available terpene blends.

In one embodiment, the flavorants may include an organosulfur compound. Suitable organosulfur compounds include, without limitation, prenyl mercaptan, 2-methylthiophene, 3-methylthiophene, diprenyl disulfide, 3-methyl-2-buten-1-yl thiolacetate, 3-methyl-1-[(3-methyl-2-buten-1-yl) sulfanyl]-2-butene, prenylmethylsulfide (1-(methylsulfanyl)-3-methyl-2-butene), prenyl thioacetate, thiogeraniol, or a combination of any two or more thereof.

In at least one embodiment, the flavorant may be emulsified into a water-soluble liquid or water-soluble powder. In one embodiment, the flavorant may include exogenously added hop oil. In one embodiment, the flavorant may be infused into hop materials. Flavor carriers can improve the sweetness, texture, and shelf life of food and beverages. In other embodiments, the flavorant can be used as such and added directly to consumable products without being infused into hop materials. In one embodiment, The flavorant may be incorporated into a carrier system to provide a flavorant matrix. The flavorant matrix may then be exogenously added, emulsified, and added or infused into a hop material and then added to the composition.

The emulsion composition may include about 0.0001% to about 30% of flavorants by weight of the total weight of the emulsion composition. In one embodiment, the emulsion composition may include up to about 30% by weight of flavorants of the total emulsion composition, including up to about 20%, up to about 10%, up to about 5%, up to about 2%, up to about 1% or up to about 0.1% by weight of the total weight of the emulsion composition. In one embodiment, the emulsion composition may include at least about 0.0001% by weight of flavorants of the total weight of the emulsion composition, including at least about 0.001%, at least about 0.01%, at least about 0.05%, at least about 0.1%, at least about 0.5%, at least about 1% or at least about 2% by weight. In one embodiment, the emulsion composition may include about 0.0001% to about 30% of flavorants of the total weight of the composition, including without limitation, about 0.001% to about 20%, about 0.005% to about 15%, about 0.01% to about 10%, about 0.05% to about 8%, about 0.1% to about 5%, about 0.5% to about 5%, or about 1% to about 5% by weight of the total weight of the emulsion composition, or any range including and/or in-between any two of these values. In certain embodiments, the flavorant may be present in an amount of from about 0.001 wt. % to about 10 wt. %, based on the total weight of the emulsion composition.

The emulsion compositions described herein include one or more preservatives. In one embodiment, the emulsion compositions described herein include one or more preservatives comprising a hop acid and/or a salt thereof. In one embodiment, the hop acid is obtained by extraction of hops, e.g., CO₂ or butane hash oil (BHO extraction of crude/raw hops. Suitable hop acids include, but are not limited to, alpha acids, beta acids, tetra acids, iso-alpha acids, and salts thereof. Illustrative alpha acids include, without limitation, humulone, cohumulone, adhumulone, and the like or salts thereof. Illustrative beta acids include, without limitation lupulone, colupulone, adlupulone, and the like or salts thereof. Illustrative tetra acids include, without limitation, tetrahydroisohumulone, tetrahydroisocohumulone, tetrahydroadlupulone and the like or salts thereof. Illustrative iso-alpha acids include, without limitation, isohumulone, isocohumulone, isoadhumulone and the like or salts thereof. In one embodiment, the preservative may be humulone, cohumulone, adhumulone, lupulone, colupulone, adlupulone, tetrahydroisohumulone, tetrahydroisocohumulone, tetrahydroadlupulone, isohumulone, isocohumulone, isoadhumulone and the like and/or salts thereof. Suitable acid salts include, but are not limited to, sodium, calcium, potassium, and magnesium salts of alpha, beta, tetra, and iso-alpha acids. For example, this may include potassium humulone, potassium cohumulone, potassium cohumulone, potassium humulone, potassium cohumulone, potassium adhumulone, potassium lupulone, potassium colupulone, potassium adlupulone, potassium tetrahydroisohumulone, potassium tetrahydroisocohumulone, potassium tetrahydroadlupulone, potassium isohumulone, potassium isocohumulone, and potassium isoadhumulone or a combination of any two or more thereof. In one embodiment, the one or more preservatives includes a potassium salt of an alpha acid.

In one embodiment, the emulsion compositions described herein include one or more preservatives comprising Vitamins (e.g., vitamin C/ascorbic acid, vitamin E/tocopherol) or a salt thereof (e.g., potassium ascorbate), organic acids (e.g., citric acid), enzymes (e.g., lysozyme), lactoperoxidase, lactoferrin, peptides, polysaccharides (e.g., chitosan), polyphenols, and essential oils, and derivatives thereof, and the like or a combination of two or more thereof. Suitable vitamins and derivatives thereof may include, without limitation, vitamin E, and related derivatives, such as tocotrienols, α-, β-, γ-, δ-, ϑ-tocopherol, and their derivatives, such as the corresponding acetates and succinates and α-, β-, γ-, and δ-tocotrienol; Vitamin C and related derivatives, e.g., ascorbyl palmitate. Suitable vitamin salts include, but are not limited to, sodium, calcium, potassium, and magnesium salts, e.g., sodium ascorbate, calcium ascorbate, potassium ascorbate, sodium ascorbyl phosphate, and magnesium ascorbyl phosphate. Suitable essential oils and extracts may include, but are not limited to, plant based oils and extracts obtained from aniseed, basil, calms, camphor, cedar wood, cinnamon, clove, eucalyptus, geranium, ginger, lavender, lemon, lemongrass, lime, marjoram, mint, nutmeg, oregano, rosemary, sage, tea leaves, vetiver, and winter green. In one embodiment, the one or more preservatives includes ascorbic acid, tocopherol, and derivatives thereof. In one embodiment, the one or more preservatives includes potassium ascorbate, sodium ascorbate, and derivatives thereof. In one embodiment, the one or more preservatives includes ascorbic acid and/or a salt thereof.

The emulsion compositions may include a combination of vitamins and vitamin salts. Vitamins are used to control the pH, making emulsions possible despite the high acidity of some emulsion components such as terpenes/flavors. In one embodiment, the pH of the emulsion can be maintained, for example, within the range of 2.0 to 10.0, preferably 3.0 to 7.0 to optimize the stability and antimicrobial efficacy. Salts derived from the vitamins are used to stabilize the emulsions through electrostatic repulsion as well as steric hindrance effects often focus on intramolecular interactions. steric hindrance significantly reduces the chances of coalescence, where two droplets merge to form a larger droplet. The use of vitamins and vitamin salts combination is instrumental in maintaining the stability and uniformity of the emulsion over time. Suitable vitamins and vitamin salts include ascorbic acid (Vitamin C), tocopherol (Vitamin E), vitamin A, carotene, derivatives thereof and salts thereof. In one embodiment, the one or more preservatives includes ascorbic acid and sodium ascorbate. In one embodiment, the one or more preservatives includes ascorbic acid and potassium ascorbate.

The vitamin and vitamin salt are present in a weight ratio ranging from 0.5:1 to 1:10, including without limitation, about 0.65:1 to about 1:8, about 0.75:1 to about 1:7.5, about 0.9:1 to about 1:6, about 1:1 to about 1:5, about 1:1 to about 1:4.5, or about 1:1 to about 1:4, and ratios in between and including the two values. In any embodiment, the ratio of vitamin to vitamin salt may range from about 1:1 to about 1:5.

The one or more preservatives may constitute about 0.0001% to about 30% by weight of the total weight of the emulsion composition. In one embodiment, the one or more preservatives may constitute up to about 30% by weight of the total emulsion composition, including up to about 20%, up to about 10%, up to about 5%, up to about 2%, up to about 1% or up to about 0.1% by weight of the total weight of the emulsion composition. In one embodiment, the one or more preservatives constitute at least about 0.0001% by weight of the total weight of the emulsion composition, including at least about 0.001%, at least about 0.01%, at least about 0.05%, at least about 0.1%, at least about 0.5%, at least about 1% or at least about 2% by weight. In one embodiment, the one or more preservatives constitute about 0.0001% to about 30% of the total weight of the composition, including without limitation, about 0.001% to about 20%, about 0.005% to about 15%, about 0.01% to about 10%, about 0.05% to about 8%, about 0.1% to about 5%, about 0.1% to about 3%, or about 0.1% to about 2% of the total weight of the emulsion composition, or any range including and/or in-between any two of these values. In certain embodiments, the preservatives is present in an amount of from about 0.001 wt. % to about 10 wt. %, based on the total weight of the of the emulsion composition. In certain embodiments, the preservatives is present in an amount of from about 0.001 wt. % to about 2 wt. %, based on the total weight of the of the emulsion composition.

The emulsion compositions may additionally include one or more emulsifier adjuvants. Suitable emulsifier adjuvants may include, but are not limited to, acids, salts, components of hop materials, and other emulsion formulation components. Illustrative emulsifier adjuvants may include, but are not limited to chitosan, inulin, carrageenan, flaxseed mucilage, water soluble fraction of almond gum, maltodextrins, carbohydrates such as sugars (e.g., sucrose, glucose, fructose, trehalose, maltose, mannose; starches and modified starches (e.g., corn starch, rice starch, quinoa starch, mucunae bean starch (Mucuna Pruriens), oat beta glucans, barley beta glucans, pectin, low methoxyl pectin, pullulan, dextran, citric acid, tartaric acid, caffeic acid, ferulic acid, sodium citrate, potassium citrate, hop acids (e.g., both isomerized and un-isomerized acids), rho iso-extract, tetra iso-extract, xanthohumol, Vitamin B, Vitamin K, and the like or a combination of any two or more thereof. Some emulsifier adjuvants can be multifunctional, possessing both stability to the emulsion system and acting as a flavor enhancer (e.g., citric acid and salts thereof).

The emulsifier adjuvants can be introduced separately in either the oil phase or the water phase prior to forming the emulsion. In one embodiment, the emulsifier adjuvants are included in the oil phase. In one embodiment, the emulsifier adjuvants are included in the water phase. In one embodiment, the emulsifier adjuvants are included in both the oil phase and the water phase. In one embodiment, the emulsifier adjuvants are simultaneously in both the oil phase and the water phase prior to forming the emulsion. Some of the non-limiting benefits associated with the use of an emulsifier adjuvant include, elimination of weighting agents, reduced turbidity, enhanced ease of emulsion formation, increased emulsion stability, decreased loss of flavor volatiles, and extended emulsion shelf-life.

In one embodiment, the emulsion composition may include about 0.0001% to about 15% by weight of emulsifier adjuvants of the total weight of the emulsion composition. In one embodiment, the emulsion composition may include up to about 10% of emulsifier adjuvants by weight of the total emulsion composition, including up to about 8%, up to about 6%, up to about 5%, up to about 2%, up to about 1% or up to about 0.1% by weight of the total weight of the emulsion composition. In one embodiment, the emulsion composition may include at least about 0.0001% of emulsifier adjuvants by weight of the total weight of the emulsion composition, including at least about 0.001%, at least about 0.01%, at least about 0.05%, at least about 0.1%, at least about 0.5%, at least about 1% or at least about 2% by weight. In one embodiment, the emulsion composition may include about 0.0001% to about 15% of emulsifier adjuvants of the total weight of the composition, including without limitation, about 0.001% to about 12%, about 0.005% to about 10%, about 0.01% to about 8%, about 0.05% to about 6%, about 0.1% to about 5%, about 0.1% to about 3%, or about 0.1% to about 2% by weight of the total weight of the emulsion composition, or any range including and/or in-between any two of these values. In certain embodiments, the emulsifier adjuvant is present in an amount of from about 0.001 wt. % to about 10 wt. %, based on the total weight of the of the emulsion composition. In certain embodiments, the emulsifier adjuvant is present in an amount of from about 0.01 wt. % to about 5 wt. %, based on the total weight of the of the emulsion composition.

In one embodiment, the emulsion compositions described herein are substantially free of a weighting agent and/or gum acacia. Commonly used weighting agents include, but are not limited to brominated vegetable oil (BVO), glycerol ester of wood rosin/glyceryl abietate (ester gum), sucrose acetate isobutyrate (SAIB), sucrose octa-isobutyrate, sucrose octa-acetate, sucrose hepta-isobutyrate, sucrose octa-propionate, propylene glycol dibenzoate, glycerol tribenzoate, methyl ester of hydrogenated rosin, calcium carbonate, manganese tetraoxide, and combinations thereof. In one embodiment, the emulsion compositions contains less than about 0.1 wt. %, less than about 0.01 wt. %, less than about 0.001 wt. %, or less than about 0.0001 wt. %, of the weighting agent (e.g., ester gum, BVO, SAIB, etc.) and/or gum acacia. In one embodiment, the emulsion compositions described herein are free any weighting agent and/or gum acacia, meaning that the weighting agent (e.g., ester gum, BVO, SAIB, etc.) and/or gum acacia is completely absent from the emulsion composition or that the emulsion composition includes 0 wt. % of a weighting agent.

The emulsion compositions may further include, either in the oil phase, the aqueous phase or both, additional additives that may provide additional benefits such as enhancements to texture, appearance, stability (chemical, physical, and microbiological stability), shelf-life and other functional benefits. Suitable additional additives include, but are not limited to, antimicrobial agents (e.g., substances used to preserve food by preventing the growth of microorganisms and subsequent spoilage, including fungistats, mold and rope inhibitors, and other effects listed by the national academy of sciences/national research council under “preservatives”); antioxidants (e.g., substances used to preserve food by retarding deterioration, rancidity, or discoloration due to oxidation); colors and coloring adjuncts (e.g., substances used to impart, preserve, or enhance the color or shading of food, including color stabilizers, color fixatives, and color-retention agents); curing and pickling agents (e.g., substances that impart a unique flavor and/or color to food, usually increasing shelf life stability); drying agents (e.g., substances with moisture-absorbing abilities, used to maintain an environment of low moisture); enzymes (e.g., enzymes used to improve food processing and the quality of the finished food); firming agents (e.g., substances added to precipitate residual pectin, strengthening the supporting tissue and preventing collapse during processing); flour treating agents (e.g., substances added to milled flour to improve its color and/or baking qualities, including bleaching and maturing agents); formulation aids (e.g., substances used to promote or produce a desired physical state or texture in food, including carriers, binders, fillers, plasticizers, film-formers, and tableting aids); humectants (e.g., hygroscopic substances incorporated in food to promote moisture retention, including moisture-retention agents and antidusting agents); leavening agents (e.g., substances used to produce or stimulate the production of carbon dioxide in baked goods to impart a light texture, including yeast, yeast foods, and calcium salts listed under “dough conditioners”); nutrient supplements (e.g., substances necessary for the body's nutritional and metabolic processes); oxidizing and reducing agents (e.g., substances that chemically oxidize or reduce another food ingredient, thereby producing a more stable product, including effects listed under “dough conditioners”); pH control agents (e.g., substances added to change or maintain active acidity or basicity, including buffers, acids, alkalis, and neutralizing agents); processing aids (e.g., substances used as manufacturing aids to enhance the appeal or utility of a food or food component, including clarifying agents, clouding agents, catalysts, flocculents, filter aids, and crystallization inhibitors); sequestrants (e.g., substances that combine with polyvalent metal ions to form a soluble metal complex, improving the quality and stability of products); solvents, carriers and vehicles (e.g., substances used to extract or dissolve another substance); stabilizers and thickeners (e.g., substances used to produce viscous solutions or dispersions, to impart body, improve consistency, or stabilize emulsions, including suspending agents, bodying agents, setting agents, jellying agents, and bulking agents); surface-active agents (e.g., substances used to modify surface properties of liquid food components for various effects, including solubilizing agents, dispersants, detergents, wetting agents, rehydration enhancers, whipping agents, foaming agents, and defoaming agents); synergists (e.g., substances that react with another food ingredient to produce an effect different or greater than the sum of the effects produced by the individual ingredients); texturizers (e.g., substances that affect the appearance or feel of the food); acids, including inorganic and organic acids and their salts (e.g., citric acid, tartaric acid, malic acid, folic acid, fumaric acid, lactic acid, acetic acid, phosphoric acid, ascorbic acid); salts including hydroxides, carbonates, bicarbonates, chlorides, gluconates, acetates, sulfides and sulfides of sodium, potassium, calcium, magnesium, and the like (e.g., chlorides, such as sodium chloride, potassium chloride, and magnesium chloride; carbonate salts, such as sodium carbonate, potassium carbonate, and calcium carbonate; bicarbonate salts, such as sodium bicarbonate; phosphate salts, such as disodium hydrogen phosphate, trisodium phosphate, dipotassium hydrogen phosphate, and tripotassium phosphate; sodium polyphosphate; citrate salts, such as sodium citrate; hydroxides such as sodium hydroxide, potassium hydroxide, magnesium hydroxide; acetates such as sodium acetate, potassium acetate; lactates such as sodium lactate, calcium lactate, magnesium lactate); and the like, or combinations thereof. Depending upon the end application, the compositions may include other ingredients, such as surfactants, co-solvents, propellants, other flavoring agents, medicinal agents, perfumes, stabilizers, thickeners, binders, preservatives, emulsifiers, essential oils, water, sweeteners, gelatin, food additives, colorants, carriers, excipients, diluents, and the like or a combination of any two or more thereof.

When included, the emulsion composition may include about 0.001% to about 20% of additional additives by weight of the total weight of the emulsion composition, including without limitation, about 0.005% to about 15%, about 0.01% to about 10%, about 0.05% to about 8%, about 0.1% to about 5%, about 0.1% to about 3%, or about 0.1% to about 2% by weight of the total weight of the emulsion composition or any range including and/or in-between any two of these values. In certain embodiments, the additional additives is present in an amount of from about 0.001 wt. % to about 10 wt. %, based on the total weight of the of the emulsion composition.

The amount of acids and salts described herein in the water phase can be adjusted to optimize emulsion stability. For example, the concentration of the salts and acids in the water phase can be altered to optimize the emulsion properties such as density, pH, turbidity, particle size, particle size distribution, stability, and consistency.

In one aspect, the present technology provides a composition in the form of an oil-in water emulsion comprising: an oil phase comprising from about 0.01 wt. % to about 30 wt. % of one or more flavorants; and a continuous aqueous phase comprising water, from about 0.001 wt. % to about 10 wt. % of one or more preservatives and about 0.01 wt. % to about 15 wt. % of one or more phospholipid emulsifying agent having a low content of primary ammonium groups, wherein all weight percentages are based on the total weight of the composition. The aqueous phase, the oil phase or both may optionally be about 0.01 wt. % to about 10 wt. % of one or more emulsifier adjuvants. In one embodiment, the preservative includes one or more hop acids. In one embodiment, the preservative includes one or more of alpha acids, beta acids, tetra acids, iso-alpha acids, and salts thereof. In one embodiment, the preservative may be humulone, cohumulone, adhumulone, lupulone, colupulone, adlupulone, tetrahydroisohumulone, tetrahydroisocohumulone, isohumulone, tetrahydroadlupulone, isocohumulone, isoadhumulone and the like or salts thereof. In one embodiment, the preservative is an alpha acid or a salt thereof. In one embodiment, the preservative is a potassium salt of an alpha acid. In one embodiment, the preservative is a vitamin and/or a salt thereof. In one embodiment, the flavorant includes a one or more of terpene, terpene blends, thiols, ketones, esters, aldehydes, alcohols, polyfunctional alcohols, polyfunctional thiols, heterocycles, and phenolics. In one embodiment, the flavorant includes hop oil, cannabis oil, hemp oil, hop extract, flavorant blends, hop-derived flavorant compounds, carrier oils, or non-hop derived flavorant compounds.

The emulsion compositions described herein may be used in a variety of products including edible products, aerosol products, aroma products, flavor products, and consumer products. The compositions may synergistically enhance the olfactory effects of products to which they are added. In certain embodiments, the compositions can be used as an additive to synergistically enhance the aroma and/or flavor of products such as edible products, aerosol products, aroma products, flavor products, and consumer products. In certain embodiments, the edible product is a food product or a beverage product.

The emulsion compositions described herein may be used, for example, in products including, but not limited to, baked goods and baking mixes (e.g., ready-to-eat and ready-to-bake products, flours, and mixes requiring preparation); alcoholic beverages (e.g., malt beverages, wines, distilled liquors, and cocktail mixes), nonalcoholic beverages (e.g., special or spiced teas, soft drinks, coffee substitutes, and fruit and vegetable flavored gelatin drinks); breakfast cereals (e.g., ready-to-eat, instant, and regular hot cereals); cheeses (e.g., curd and whey cheeses, cream, natural, grating, processed, spread, dip, and miscellaneous cheeses; confectionaries (e.g., chewing gum; gummies, candy, hard and soft candy, candy bars, chocolates, fudge, mints, and other chewy candies); coffee and tea (e.g., regular, decaffeinated, and instant types); condiments and relishes (e.g., plain seasoning sauces and spreads, olives, pickles, and relishes); confections and frostings (e.g., flavored frostings, marshmallows, baking chocolate, and various sugars); dairy product analogs (e.g., nondairy milk, creamers, coffee whiteners, toppings, and other nondairy products); egg products (e.g., liquid, frozen, or dried eggs); fats and oils (e.g., margarine, dressings, butter, salad oils, shortenings, and cooking oils); fish products (e.g., prepared main dishes, salads, appetizers, frozen meals, and spreads containing fish); fresh eggs (e.g., cooked eggs and dishes made from fresh shell eggs); fresh fish (e.g., fresh and frozen fish, shellfish, and other aquatic animals); fresh fruits and fruit juices (e.g., raw fruits, citrus, melons, berries, and home-prepared punches); fresh meat and meat products (e.g., fresh or home-frozen beef, veal, pork, lamb, or mutton, meat-containing dishes, salads, appetizers, frozen meals, and deli meat); fresh poultry and poultry products (e.g., fresh or home-frozen poultry and game birds, poultry and poultry-containing dishes, salads, appetizers, frozen meals, and sandwich ingredients); fresh vegetables (e.g., tomatoes, and potatoes, fresh and home-prepared vegetables); frozen dairy desserts and mixes (e.g., ice cream, ice milks, sherbets, and other frozen dairy desserts); fruit and water ices; gelatins, puddings, and fillings (e.g., flavored gelatin desserts, puddings, custards, parfaits, pie fillings, and gelatin base salads); grain products and pastas (e.g., macaroni and noodle products, rice dishes, and frozen multicourse meals); gravies and sauces (e.g., meat sauces, gravies, and various specialty sauces); hard candy and cough drops; herbs, seeds, spices, seasonings, blends, extracts, and flavorings; jams and jellies (e.g., home-prepared and commercially processed jams, jellies, fruit butters, preserves, and sweet spreads); milk and milk products (e.g., whole, low-fat, skim fluid milks, flavored milks, dry milks, toppings, snack dips, spreads, weight control milk beverages, and other milk origin products); nuts and nut products (e.g., whole or shelled tree nuts, peanuts, coconut, and nut spreads); plant protein products (e.g., meat, poultry, and fish substitutes, analogs, and extender products made from plant proteins); processed fruits and fruit juices (e.g., commercially processed fruits, salads, juices, punches, concentrates, and drink substitutes); processed vegetables and vegetable juices (e.g., commercially processed vegetables, dishes, frozen meals, and vegetable juices); snack foods (e.g., chips, pretzels, and other novelty snacks); soups and soup mixes (e.g., home-prepared and commercially made meat, fish, poultry, vegetable, and combination soups; white granulated sugar; granulated, liquid, and tablet sugar substitutes; sweet sauces, toppings, and syrups (e.g., chocolate, berry, fruit, corn syrup, and maple sweet sauces and toppings). These potential applications, illustrate the versatility and wide-reaching impact of the emulsion compositions provided in the disclosure.

In another aspect, the present technology relates to various products that may include the emulsion compositions described herein. Illustrative products include, without limitation, edible products, aerosol products, aroma products, or flavor products. In certain embodiments, an edible product comprising an emulsion composition described herein is provided. In certain embodiments, the edible product is a food or beverage product. In certain embodiments, the beverage is beer, any alcohol containing beverage, or other non-alcohol beverage product. In certain embodiments, a flavor and aroma product comprising the emulsion composition described herein is provided. In certain embodiments, a flavor and/or aroma delivery system comprising the emulsion composition described herein is provided. In one embodiment, the present technology relates to beverage products that may include the emulsion compositions described herein. In one embodiment, the present technology relates to beer products that may include the emulsion compositions described herein.

In one embodiment, provided is a stable foam formulation comprising the oil-in-water emulsion composition of the present technology. In one embodiment, provided is a beverage, such as beer, comprising the oil-in-water emulsion composition of the present technology. In one embodiment, the concentration of the emulsion composition in the beverage ranges from about 0.1% to about 5% by volume

In another aspect, the present technology relates to methods for preparing an oil-in-water emulsion. For example, provided herein are methods for preparing an oil-in-water emulsion said method comprising: (i) providing an oil phase comprising one or more flavorant additives and one or more emulsifier adjuvants; (ii) providing an aqueous phase comprising water and one or more phospholipid emulsifying agent having a low content of the primary ammonium group, and optionally one or more emulsifier adjuvants; (iii) mixing said oil phase and said aqueous phase so as to obtain said oil-in-water emulsion.

In another aspect, the method for preparing an oil-in-water emulsion further includes preparation of the phospholipid emulsifying agent, wherein the method includes, (a) subjecting a natural source of phospholipids to extraction methods to obtain a phospholipid fraction; (b) purifying the phospholipid fraction; and (c) removing the excess ammonium groups from the phospholipid fraction.

The emulsions of the present technology can be tested for density, pH, turbidity, particle size, particle size distribution, stability, and consistency For oil-in-water emulsions, a crucial stability factor is the electrostatic charge carried by the oil droplets. Particles that are highly positively or negatively charged will repel each other in solution and flocculation is less likely. The oil droplet surface charge is typically characterized by the emulsion's zeta potential, a measure of the sign and magnitude of the surface charge which is defined by the electrophoretic mobility of the droplets. In a typical oil-in-water emulsion, a more optimal zeta potential provides a more stable emulsion.

The emulsion compositions described herein have several advantages. For example, the emulsion compositions of the present technology may exhibit improved foam stability in beverages such as beer when compared to an identically formulated composition containing traditional emulsifiers such as lecithin. In one embodiment, the emulsion compositions of the present technology exhibit improved foam stability in beverages such as beer when compared to an identically formulated composition containing phospholipid emulsifying agent such as lecithin or sunflower lecithin containing only 65%, 60% or 50% phosphatidylcholine. In one embodiment, the emulsion compositions of the present technology exhibit improved foam stability in beverages such as beer when compared to an emulsion composition containing phospholipid emulsifying agent such as Sunlipon® 65 (phospholipid from sunflower lecithin containing at least about 60% phosphatidylcholine, Perimondo, New York, N.Y) alone. The lower content of primary ammonium functional groups in the emulsifying agent of the present technology is associated with advantages such as prevention of negative interactions with proteins and other constituents in the beverages, applicability to a wide variety of beverages, utilization of safe and effective naturally-derived phospholipids, and improved overall sensory experience of the beverage.

The compositions and methods described herein allow quick, consistent, and easy incorporation of aroma and/or flavor enhancement into diverse types of products. Additionally, the use of synthetic is avoided thereby ensuring compliance with regulatory standards, consumer preference and enhancing the safety profile of the emulsions. The present technology further improves the retention of volatile flavor and aroma compounds during emulsification, resulting in superior sensory quality of the final product. Finally, the present technology enhances the stability and shelf-life of the emulsion compositions without the need for traditional synthetic antioxidants, preservatives, and stabilizers, ensuring consistent performance over time and creates stable oil-in-water emulsions that maintain clarity in products such as beverages, enhancing visual appeal and product quality.

The emulsion compositions described herein may be used in a wide variety of products including, but not limited to, food and beverages. Illustrative beverages may include, but are not limited to, beer; gassed beverages such as soda water, carbonated water, and flavored water beverages; cola drinks, orange drinks, lemon drinks, lemonade, tonic water, root beer, ginger ale, ginger beer; dairy based beverages containing a dairy product such as milk or cream, or a milk or cream substitute, diary-free beverages, diary containing beverages (e.g., protein drinks), foamed coffee or tea or chocolate drink; or a gassed beverage containing coffee, tea, or chocolate flavoring.

In another aspect, the present technology relates to various products that may include the emulsion compositions described herein. Illustrative products include, without limitation, foamable compositions used in edible products, aerosol products, or flavor products. In certain embodiments, an edible product comprising an emulsion composition described herein is provided. In certain embodiments, the edible product is a food or beverage product. In one embodiment, the present technology relates to beverage products that may include the emulsion compositions described herein. In certain embodiments, the beverage is a fermented beverage including but not limited to kombucha and beer. In certain embodiments, the beverage is beer.

In another aspect, the present technology relates to various products that may include the emulsion compositions described herein. Illustrative products include, without limitation, foamable compositions used in edible products, aerosol products, or flavor products. In certain embodiments, an edible product comprising an emulsion composition described herein is provided. In certain embodiments, the edible product is a food or beverage product. In one embodiment, the present technology relates to beverage products that may include the emulsion compositions described herein. In certain embodiments, the beverage is a fermented beverage including but not limited to kombucha and beer. In certain embodiments, the beverage is beer.

The emulsion compositions may be included in the products in an amount suitable to provide the desired stability or other property of the product, ranging from about 0.0001% to 50% by weight or volume, including from about 0.001% to 30%, about 0.05% to 20%, about 0.01% to 10%, about 0.01% to 5%, or about 0.01% to 3%, of the total weight or volume of the product, or any range including and/or in-between any two of these values For example, when used in a beverage, the emulsion compositions may be included in a concentration range of from about 0.01% to 10%, or about 0.05% to 8%, or about 0.1% to 5%, or about 0.5% to 3%, by volume, depending on the specific beverage formulation.

In another aspect, the present technology relates to methods for preparing an oil-in-water emulsion. For example, provided herein are methods for preparing an oil-in-water emulsion said method comprising: (i) providing an oil phase comprising one or more flavorant additives; (ii) providing an aqueous phase comprising water, one or more preservatives and one or more phospholipid emulsifying agents; (iii) mixing the oil phase and the aqueous phase so as to obtain a pre-emulsion; and (iv) homogenizing the pre-emulsion to obtain an oil-in-water emulsion. In one embodiment, the homogenizing comprises a multi-stage homogenization process. The oil phase may be prepared by mixing the one or more flavorant additives. The aqueous phase is prepared by mixing the appropriate amount of phospholipid emulsifying agents, the appropriate amount of preservatives (e.g., hop acids, vitamins, and salts thereof), optionally additional emulsifying agents, and distilled water and mixing. In one embodiment, the method includes using a high-shear mixing process to enhance the uniform distribution of the ingredients.

In another aspect, the present technology provides methods for preparing a natural foam stabilizer for food and beverages. In yet another aspect, the present technology relates to methods for stabilizing foam in food and beverages. The methods includes forming and stabilizing emulsion compositions for use in food and beverages by using phospholipid emulsifying agents. In yet another aspect, the present technology provides methods for stabilizing oil-in-water emulsions and preserving products; wherein the method includes adding one or more phospholipid emulsifying agents to the emulsion.

In one aspect, the present technology provides methods for stabilizing foam in a product; wherein the method includes formulating the product with an emulsion containing oil and water; and stabilizing the emulsion by adding a phospholipid emulsifying agent comprising a fraction of phospholipids with a low content of primary ammonium functional groups. The product may be a consumer product, such as a food product or a beverage product.

In another aspect, the present technology relates to methods for preparing a natural preservative and foam stabilizer for food and beverages. In yet another aspect, the present technology relates to methods for forming and maintaining foam stability in food and beverages. The methods includes forming and stabilizing emulsion compositions for use in food and beverages by using a phospholipid emulsifying agent comprising a fraction of phospholipids with a low content of primary ammonium functional groups. In one embodiment, the emulsion composition further includes one or more of flavorant additives, one or more of alpha acids, beta acids, tetra acids, iso-alpha acids, and salts thereof, vitamins and salts thereof, emulsifying agents, and emulsifier adjuvants.

The present invention, thus generally described, will be understood more readily by reference to the following examples, which are provided by way of illustration and are not intended to be limiting of the present invention.

### EXAMPLES

Various embodiments will be further clarified by the following examples, which are in no way intended to limit this disclosure thereto.

### Example 1: Preparation of Emulsions for Foam Enhanced Emulsions

Preparation of Oil Phase: Suitable amounts (e.g., 2-20%) of oil-soluble terpenes are measured.

Preparation of 2-5% PI30 Solution: Appropriate amounts of Sunlipon® PI30 (phospholipids from sunflower lecithin, Perimondo, New York, N.Y) powder to create a 2-5% solution measured and slowly added directly to the water phase. The phospholipids contain phosphatidylinositol not less than 30%, lysophosphatidylinositol not more than 3%, phosphatidylethanolamines not less than 8% and phosphatidylcholines not less than 8% The solution is mixed for 1 h using a Silverson L5M-A mixer with a general mixing head, and its speed set to 5000 RPM, ensuring that the PI30 is fully dissolved into a homogeneous solution. After mixing, the PI30 solution is filtered to remove any impurities, and the solution is allowed to sit overnight to ensure complete filtration.

Preparation of Water Phase: Potassium sorbate (e.g., 0.1%), citric acid (e.g., 0.08%), distilled water, and/or other emulsifying adjuvants are sequentially added into a clean beaker. Alternatively or additionally a vitamin or vitamin salt, (e.g., ascorbic acid, sodium ascorbate) and/or a hop extract (e.g., alpha acid extract) is gradually added to the water phase. The solution is stirred continuously using a Silverson L5M-A mixer at low RPM to ensure full dissolution of the potassium sorbate. Suitable amount of Sunflower lecithin (SunliponR PI30 or Sunlipon PI30+SunliponR 65) is gradually added to the water phase. The resulting solution is mixed for 10-15 min using a Silverson L5M-A mixer with a general mixing head, at a speed set to 5000 RPM. The mixing is done to ensure that the emulsifier fully dissolves, and the temperature is monitored throughout the process to ensure it does not rise above desired levels. The solution is allowed to return to room temperature naturally once mixing is complete. After dissolution is completed, the pH is checked using a pH meter and adjusted if necessary to optimize for stability and preservation.

Incorporation of 2-5% PI30 Solution: The 2-5% SunliponR PI30 solution is added to water phase and continuously mixed with stirring to ensure complete incorporation.

Preparation of Pre-emulsion Solution: The oil phase is slowly added to the prepared water phase while controlling the rate of addition to facilitate emulsion formation. After the oil phase has been added, the Silverson L5M-A mixer is switched to the emulsifying head and the speed is increased to 5000 RPM. The mixture is mixed for 10 min to ensure thorough emulsification and uniform consistency. The mixture is inspected to confirm even distribution of the oil droplets in the water phase. The solution is allowed to sit for 30 min to let any excess air bubbles escape, improving the overall stability of the pre-emulsion. De-aeration can also be assisted by a vacuum chamber or desiccator if needed. This process can be done in an inert atmosphere to minimize oxygen. Alternatively or additionally, the resulting solution can be purged to remove dissolved oxygen. In another option, an inert gas blanket can be applied to minimize oxygen incorporation.

Homogenization: Before starting the homogenization process, the cooling water system and digital pressure gauge are activated to maintain temperature control and monitor homogenization pressures. 200-500 mL of distilled water is added to the feed hopper to adjust the homogenizer parameters before processing the main batch. 500 mL of the pre-emulsion is added into the feed hopper, following which the homogenizer is started and the pressure is adjusted to 10000-12000 psi for the first stage. The second-stage pressure is set to 20% of the first stage pressure (approximately 2000-2400 psi). Both the pressure and temperature are carefully monitored during this process to ensure the system operates within safe limits, as well as monitoring emulsion temperature to ensure minimal off gassing. The pre-emulsion is slowly fed into the homogenizer and processed twice to achieve optimal particle size reduction. The feed hopper is monitored to ensure it does not empty, thereby preventing cavitation. The temperature increases are monitored, ensuring they remain within a 5-10° C. rise per pass to maintain emulsion integrity. If necessary, external cooling methods are used to keep the temperature within range. The samples are collected during the second homogenization run for performing quality control testing which includes parameters like particle size, zeta potential, pH, particle size range, turbidity, acidity, and consistency. Once complete, the homogenizer pressure is disengaged by turning the hand wheels counterclockwise, bringing the pressure to zero safely. After homogenization, the emulsion is inspected for visual consistency, texture, and particle size. If possible, a particle size analyzer is used to confirm that the desired size distribution has been achieved. The final temperature, pressure, and time taken for homogenization are recorded to maintain process consistency in future batches, and the emulsion is advanced for further testing or packaging. The phospholipid emulsion system can be incorporated into various beverages, including but not limited to beer, soft drinks, and dairy-based beverages in suitable amounts (e.g., 0.1% to 5% by volume).

### Example 2: Oil-In-Water Emulsion with Different Flavorants and Emulsion Systems

Various inventive emulsion compositions were prepared using the method described in Example 1 and a phospholipid emulsifying agent comprising the specific primary ammonium functional group (Sunlipon® PI 30). The emulsion compositions were prepared using five different flavorant formulations. A listing of flavorant formulations assessed, their flavor profiles, and their general chemical composition is provided in Table 1 below:

TABLE 1

| Flavorant | Flavor | |
|---|---|---|
| Formulation | profile | Chemical composition |
| D | Honeydew | Terpenes, esters, aldehydes, volatile |
| | | sulfur compounds |
| E | Grapefruit | Terpenes, esters, aldehydes, volatile |
| | | sulfur compounds |
| F | Blood orange | Esters, aldehydes, volatile sulfur |
| | | compounds |
| G | Mango | Terpenes, esters, aldehydes, volatile |
| | | sulfur compounds |
| H | Kiwi | Terpenes, esters, aldehydes, volatile |
| | | sulfur compounds |

Using the procedure described in Example 1, the emulsion compositions prepared using different flavorants D-H from Table 1 in combination with emulsion systems (EMP-01A to EMP-01C), to study effect of changing emulsion systems and flavorants on emulsion properties of the resulting emulsion compositions. The composition of the emulsion systems is summarized in Tables 2-4 below. All amounts are in wt. %, based in the total weight of the emulsion composition, unless otherwise specified.

TABLE 2
Emulsion System - EMP-01A

| Ingredient | Relative-% | Amount |
|---|---|---|
| Water, Distilled | 96.81 | 4840.5 |
| Flavorant Formulation | 2 | 100 |
| Phospholipid Emulsifying Agent | 1 | 50 |
| Citric Acid | 0.03 | 1.5 |
| Potassium Sorbate | 0.1 | 5 |
| Sodium Citrate | 0.06 | 3 |

TABLE 3
Emulsion System - EMP-01B

| Ingredient | Relative- wt. % | Actual Amount (g) |
|---|---|---|
| Water, Distilled | 95.22 | 476.1 |
| Flavorant | 2 | 10 |
| Alpha Extract 20% | 0 | 0 |
| Ascorbic acid | 0.2 | 1 |
| Sodium Ascorbate | 0.28 | 1.4 |
| Sunlipon ®65 | 0.3 | 1.5 |
| Sunlipon ®PI30 | 2 | 2 |

TABLE 4
Emulsion System - EMP-01C

| Ingredient | Relative- wt. % | Actual Amount (g) |
|---|---|---|
| Water, Distilled | 95.153 | 475.765 |
| Flavorant | 2 | 10 |
| Alpha Extract 20% | 0.005 | 0.025 |
| Citric Acid | 0.024 | 0.12 |
| Sodium Citrate | 0.018 | 0.09 |
| Tocopherol | 0.1 | 0.5 |
| Ascorbic Acid | 0 | 0 |
| Sodium Ascorbate | 0.1 | 0.5 |
| Phospholipid Emulsifying Agent | 2-2.6 | 10 |

Five inventive emulsion compositions AD-AH prepared using different flavorants listed in Table 5 in combination with the emulsion system EMP-01B as shown in Table 5. All amounts are in wt. %, based in the total weight of the emulsion composition, unless otherwise specified.

TABLE 5

| | Flavorant | | Emulsion System-EMP-01B | | | | |
|---|---|---|---|---|---|---|---|
| Emulsion | | wt. | Sunlipon ® | Sunlipon ® | Ascorbic | Sodium | Water, |
| Composition | Formulation | % | PI30 | 65 | Acid | Ascorbate | Distilled |
| AD | D | 2 | 2 | 0.3 | 0.2 | 0.28 | 95.22 |
| AE | E | 2 | 2 | 0.3 | 0.2 | 0.28 | 95.22 |
| AF | F | 2 | 2 | 0.3 | 0.2 | 0.28 | 95.22 |
| AG | G | 2 | 2 | 0.3 | 0.2 | 0.28 | 95.22 |
| AH | H | 2 | 2 | 0.3 | 0.2 | 0.28 | 95.22 |

### Example 2: Analysis of Foam Stability

The prepared emulsions of Example 1 were evaluated for foam stability using the following methods.

The Nibem-TPH Foam Stability Tester is a specialized instrument designed to assess the stability of foam in beverages, particularly beer. It measures the time required for a foam layer to collapse by a specific distance, typically 30 millimeters, providing an objective evaluation of foam quality. To test foam stability using a Nibem instrument, especially with packaged products, a specialized setup is essential for preserving sample integrity and preventing oxygen pickup requires a piercing device. This device attaches securely to the package, allowing access to the sample while maintaining a closed environment. The sample tube in the piercing device has a pop-off valve that seals automatically, preventing liquid from draining or air from entering, which minimizes oxygen exposure. This setup ensures that foam properties remain consistent until measurement. After attaching the piercing device, N₂ or CO₂ is introduced into the sample to generate foam required for Nibem instrument. The Nibem instrument then measures foam stability, recording the time it takes for foam to dissipate by a set distance (10-30 mm), with results displayed in seconds or Nibem units. This method provides reliable and accurate results even for sealed packages, making it a robust solution for evaluating foam stability without introducing external factors.

A pale lager, known for its smooth, crisp taste and light golden color (Modelo Especial) was used as the control. 0.1% by weight of the emulsion compositions of the present technology (AD-AH) were introduced into the control to test foam stability and compared to the control beer not containing any emulsion composition.

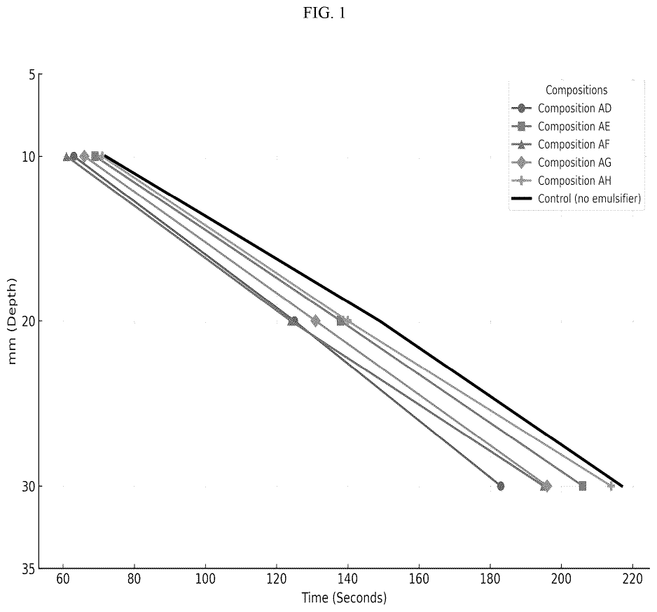

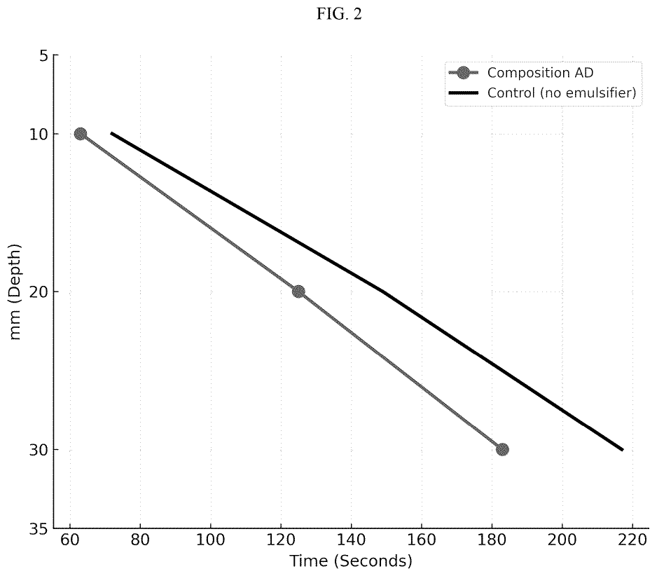

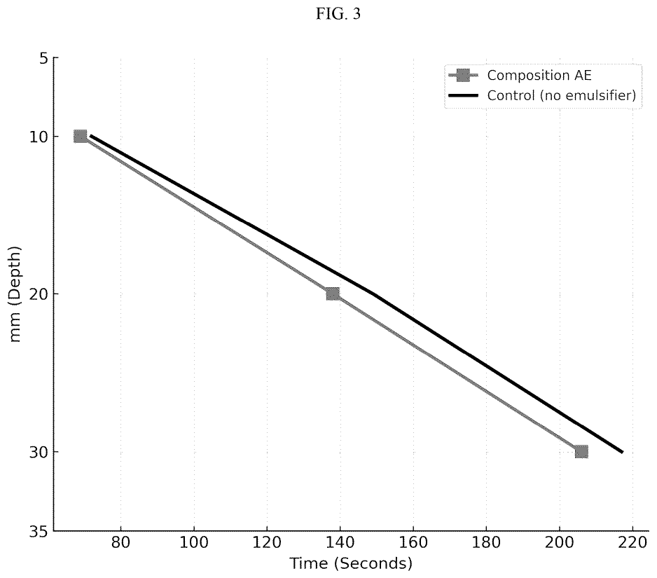

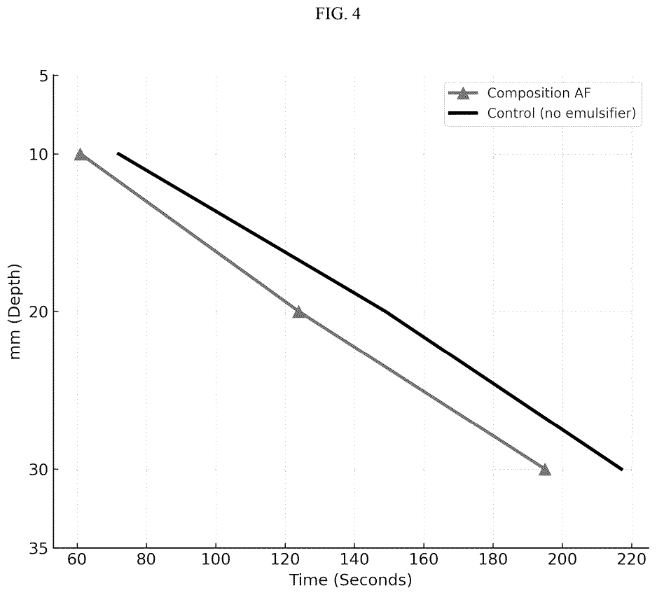

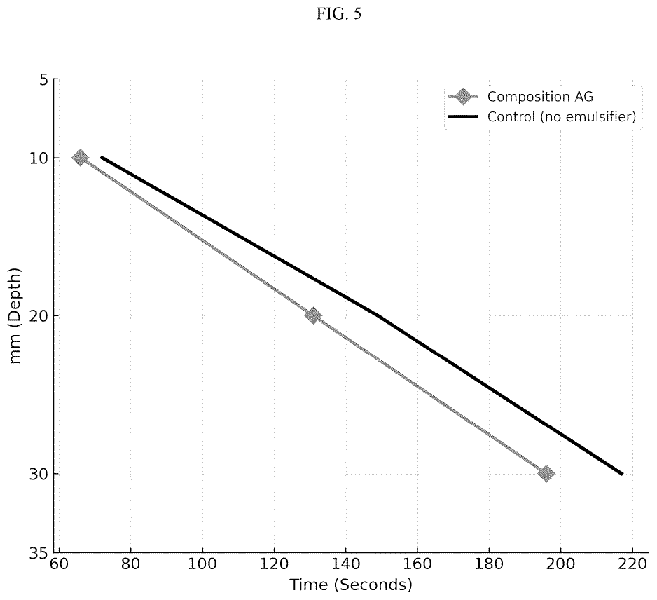

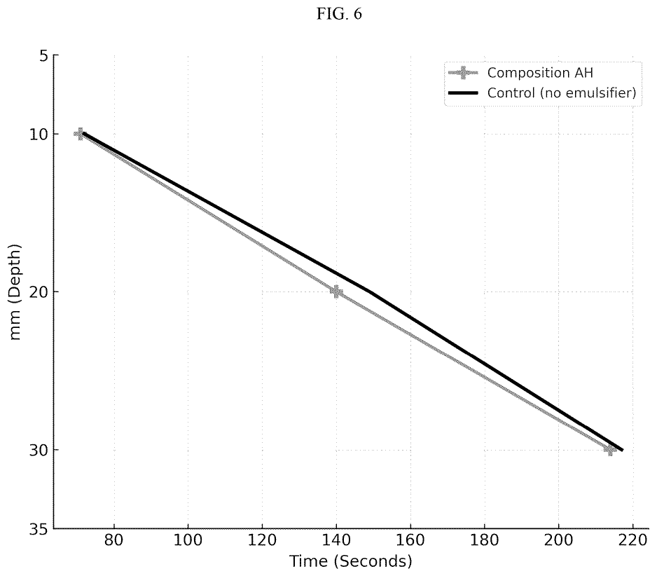

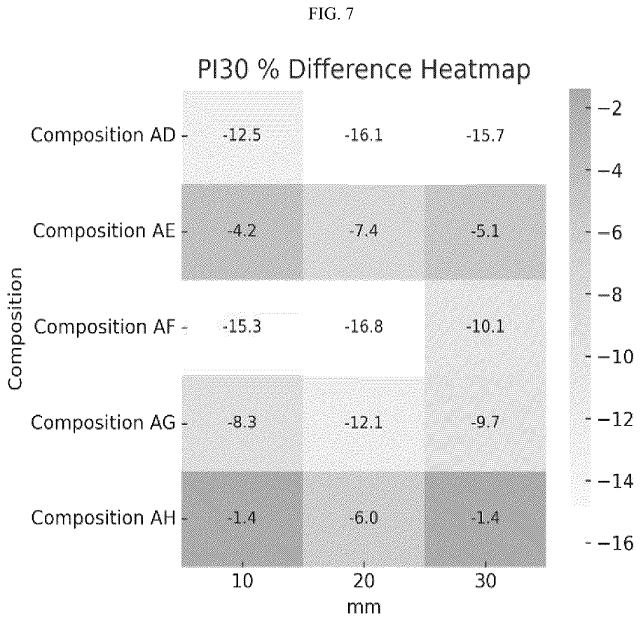

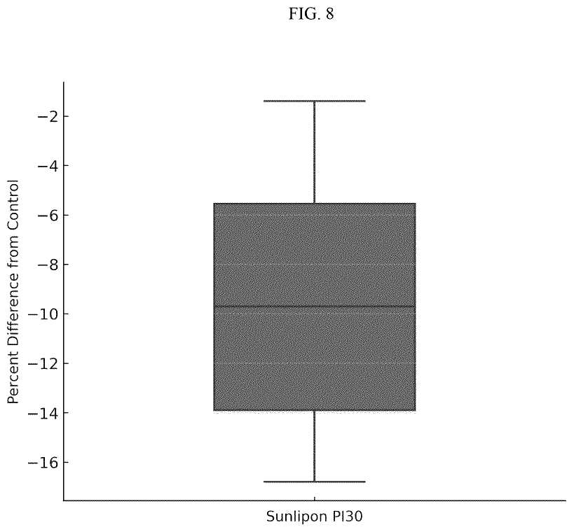

The results are shown in FIGS. 1-7, which shows the foam stability plot for prepared samples. Measurement is made by determining the amount of time required for foam to decay 10, 20, and 30 mm. The foam stability data clearly demonstrate that SunliponR PI30, a phosphatidylinositol-based emulsifier, provides excellent foam stability. The control sample, which contained no emulsifier, served as a baseline representing the natural rate of foam collapse without stabilization. Percent deviations from this control—calculated by comparing foam collapse times at 10, 20, and 30 mm depths—showed that foams stabilized with Sunliponx PI30 deviated only by approximately −1% to −16%, indicating that SunliponR PI30 maintained foam integrity much closer to the control. These values quantify how much faster each foam collapsed relative to the control, with smaller negative percentages corresponding to slower collapse and thus greater foam stability. Across all compositions (AD-AH), SunliponR PI30 consistently preserved foam structure for extended periods of time. This difference was most pronounced at greater foam depths (20-30 mm), where drainage and film rupture become more significant. FIG. 8 provides a box plot showing a compact and statistical visualization of the foam stability provided by SunliponR PI30 (phosphatidylinositol-based) containing emulsions relative to the control, which does not include any emulsion compositions. The box represents the distribution of percent deviations from the control across all compositions (AD-AH) and depths (10, 20, 30 mm). In this plot, the Sunlipon PI30 box is positioned higher on the y-axis (closer to zero) and is noticeably narrower, indicating that foams stabilized with PI30 collapsed more slowly and consistently across all conditions. The median line within the PI30 box sits near the top of the range, showing that most PI30 samples performed close to the control-signifying strong and reproducible foam stabilization. Visual analyses reinforce these trends: SunliponR PI30 data cluster tightly near the control line with narrow interquartile ranges, demonstrating high reproducibility and uniform stabilization. This enhanced foam longevity is especially relevant for formulations where stable, long-lasting foam is desirable, such as in beverages, nutraceuticals, and cosmetic systems. Overall, these results confirm that SunliponR PI30 is a highly effective and reliable emulsifier offering superior foam stability, reproducibility, and formulation robustness for advanced product development. The emulsion compositions containing the innovative phospholipid emulsion systems of the present technology also showed substantially improved foams stabilization compared to emulsion compositions containing a regular, full lecithin emulsion.

These results show that the emulsions are stable using the innovative phospholipid emulsion systems of the present technology.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation, or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. An oil-in-water emulsion composition comprising:
an oil phase comprising:
about 0.01 wt. % to about 30 wt. %, based on a total weight of the emulsion composition, of a flavorant; and
optionally about 0.01 wt. % to about 10 wt. %, based on a total weight of the emulsion composition, of an emulsifier adjuvant; and
a continuous aqueous phase comprising:
water;
about 0.01 wt. % to about 30 wt. %, based on a total weight of the emulsion composition, of a preservative; and
about 0.01 wt. % to about 10 wt. %, based on a total weight of the emulsion composition, of a phospholipid emulsifying agent, wherein the phospholipid emulsifying agent comprises from about 0.001 mmol to about 1.0 mmol of primary ammonium functional group per gram of the phospholipid emulsifying agent.

2. The oil-in-water emulsion composition of claim 1, wherein the phospholipid emulsifying agent comprises a lecithin.

3. The oil-in-water emulsion composition of claim 2, wherein the lecithin comprises a sunflower lecithin.

4. The oil-in-water emulsion composition of claim 1, wherein the phospholipid emulsifying agent comprises from about 0.04% to about 0.6% by weight of phosphatidylinositol (PI), from about 0.04% to about 0.1% by weight of lysophosphatidylinositol (LPI), from about 0.1% to about 0.2% by weight of phosphatidylethanolamines (PE), and/or from about 0.3% to about 0.6% of phosphatidylcholines (PC), based on a total weight of the phospholipid emulsifying agent.

5. The oil-in-water emulsion composition of claim 1 comprising about 0.01% to about 5% by weight of the total weight of the emulsion composition, of the phospholipid emulsifying agent.

6. The oil-in-water emulsion composition of claim 1, wherein the flavorant comprises hop oil, cannabis oil, hemp oil, hop extract, flavorant blends, hop-derived flavorant compounds, carrier oils, or non-hop derived flavorant compounds.

7. The oil-in-water emulsion composition of claim 1, wherein the flavorant comprises a terpene, a thiol, a ketone, an esters, an aldehyde, an alcohol, a heterocycle, or a phenolic.

8. The oil-in-water emulsion composition of claim 1, wherein the aqueous phase comprises about 0.01 wt. % to about 10 wt. % of a preservative comprising a hop acid or a salt thereof.

9. The oil-in-water emulsion composition of claim 8, wherein the preservative comprises the hop acid, and the hop acid comprises an alpha acid, a beta acid, a tetra acid, or an iso-alpha acid.

10. The oil-in-water emulsion composition of claim 8, wherein the preservative comprises: (a) the hop acid, and the hop acid comprises humulone, cohumulone, adhumulone, lupulone, colupulone, adlupulone, tetrahydroisohumulone, tetrahydroisocohumulone, tetrahydroadlupulone, isohumulone, isocohumulone, or isoadhumulone; or (b) the hop acid salt, and the hop acid salt comprises potassium humulone, potassium cohumulone, potassium cohumulone, potassium humulone, potassium cohumulone, potassium adhumulone, potassium lupulone, potassium colupulone, potassium adlupulone, potassium tetrahydroisohumulone, potassium tetrahydroisocohumulone, potassium tetrahydroadlupulone, potassium isohumulone, potassium isocohumulone, or potassium isoadhumulone.

11. The oil-in-water emulsion composition of claim 1, wherein the aqueous phase comprises about 0.01 wt. % to about 10 wt. % of a preservative comprising a vitamin and a salt thereof.

12. The oil-in-water emulsion composition of claim 11, wherein the vitamin comprises (a) vitamin C, vitamin E, vitamin A carotene, and derivatives thereof; or (b) ascorbic acid, α-tocopherol, β-tocopherol, γ-tocopherol, δ-tocopherol, ϑ-tocopherol, α-tocotrienol, β-tocotrienol, γ-tocotrienol, or δ-tocotrienol.

13. The oil-in-water emulsion composition of claim 11, wherein the vitamin salt comprises sodium ascorbate, calcium ascorbate, potassium ascorbate, ascorbyl palmitate, sodium ascorbyl phosphate, or magnesium ascorbyl phosphate.

14. The oil-in-water emulsion composition of claim 1, further comprising an additional emulsifying agent comprising gum arabic, ester gum, acacia gum, xanthan gum, guar gum, carrageenan, locust bean gum, monoglycerides, diglycerides, ethoxylated castor oil, albumin, alginates, casein, egg yolk, or glycerol monostearate.

15. The oil-in-water emulsion composition of claim 1, wherein the emulsifier adjuvant comprises citric acid, malic acid, tartaric acid, ascorbic acid, caffeic acid, ferulic acid, or a salt thereof.

16. The oil-in-water emulsion composition of claim 1, wherein the water is present in an amount corresponding to the remaining balance of material in the oil-in-water emulsion composition.

17. The oil-in-water emulsion composition of claim 1, wherein the oil-in-water emulsion composition is substantially free of weighting agents and gum acacia.

18. A stable foam formulation or a beverage comprising the oil-in-water emulsion composition of claim 1.

19. A method comprising:
providing an oil phase comprising a flavorant and optionally an emulsifier adjuvant;
providing an aqueous phase comprising water, a preservative, a phospholipid emulsifying agent, and optionally an emulsifier adjuvant;
mixing the oil phase and the aqueous phase to obtain a pre-emulsion; and
homogenizing the pre-emulsion to obtain an oil-in-water emulsion;
wherein the phospholipid emulsifying agent comprises about 0.001 to about 1.0 mmol of primary ammonium functional group per gram of the phospholipid emulsifying agent; optionally wherein the homogenizing comprises a multi-stage homogenization process.

20. A method for stabilizing a foam composition, the method comprising adding to the foam composition an oil-in-water emulsion comprising from about 0.01 wt. % to about 10 wt. %, based on the total weight of the emulsion composition, of a phospholipid emulsifying agent, wherein the phospholipid emulsifying agent comprises about 0.001 to about 1.0 mmol of primary ammonium functional group per gram of the phospholipid emulsifying agent, and wherein the oil-in-water emulsion and the foam composition are free of weighting agents and gum acacia.
